(19) United States
(12) Patent Application Publication
(10) Pub. No.: US 2022/0081017 A1
(43) Pub. Date: Mar. 17, 2022

(54) PIPE RACK TRANSPORT AND INSTALLATION CART

(71) Applicant: Electrical Specialists Inc. DBA The Superior Group, Columbus, OH (US)

(72) Inventors: Bill Stranahan, Grove City, OH (US); John Alexander, Alexandria, OH (US)

(21) Appl. No.: 17/474,006

(22) Filed: Sep. 13, 2021

Related U.S. Application Data
(60) Provisional application No. 63/077,693, filed on Sep. 13, 2020.

(51) Int. Cl. B62B 3/10

(52) U.S. Cl. CPC B62B 3/102; B62B 2301/044; B62B 2202/02; B62B 3/104

(57) ABSTRACT

A conduit rack transport and installation cart is provided, the cart comprising: base frame elements oriented into a horizontal rectangle having four corners; vertical stacking elements extending vertically upwardly from the four corners, wherein a lower end of each vertical stacking element includes a female receiver element sized to accept insertion of an upper end of each vertical stacking element; a plurality of raised conduit supports extending across a width of the cart in a lateral direction; fork pockets extending from a lower side of the base frame elements; and removable casters engaging the female receiver elements.

### CROSS-REFERENCE TO RELATED APPLICATIONS

This application claims priority from U.S. Provisional Patent Application No. 63/077,693, filed on Sep. 13, 2020, which is incorporated by reference herein in its entirety.

### BACKGROUND

During the construction of structures, it is common to run electrical wires through conduit to meet with electrical codes, protect the wires, protect individuals who may contact the wires, and/or to maintain an orderly and clean appearance. Often times, the conduit is run in an area hanging from the ceiling of the structure, including on conduit trapeze hangers. The conduit may be laid out and clamped to the trapeze hangers offsite to permit easier and faster installation at the worksite. However, it can be difficult to transport the assembled conduit, including where sections of threaded rod or cable studs are installed vertically upwardly from the trapeze hangers. Simply stacking these preassembled elements would damage those vertically upwardly extending elements.

What is needed is an easy transport and installation solution for preassembled conduit runs.

### SUMMARY

In one aspect, a conduit rack transport and installation cart is provided, the cart comprising: base frame elements oriented into a horizontal rectangle having four corners; vertical stacking elements extending vertically upwardly from the four corners, wherein a lower end of each vertical stacking element includes a female receiver element sized to accept insertion of an upper end of each vertical stacking element; a plurality of raised conduit supports extending across a width of the cart in a lateral direction; fork pockets extending from a lower side of the base frame elements; and removable casters engaging the female receiver elements.

In another aspect, a conduit rack transport and installation cart is provided, the cart comprising: base frame elements oriented into a horizontal rectangle having four corners; vertical stacking elements extending vertically upwardly from the four corners, wherein a lower end of each vertical stacking element includes a female receiver element sized to accept insertion of an upper end of each vertical stacking element; and a plurality of raised conduit supports extending across a width of the cart in a lateral direction.

### BRIEF DESCRIPTION OF THE DRAWINGS

The accompanying figures, which are incorporated in and constitute a part of the specification, illustrate various example systems and apparatuses, and are used merely to illustrate various example embodiments. In the figures, like elements bear like reference numerals.

FIG. 1A illustrates a perspective view of a conduit rack transport and installation cart 100.

FIG. 1B illustrates an elevation view of conduit rack transport and installation cart 100.

FIG. 1C illustrates a plan view of conduit rack transport and installation cart 100.

FIG. 1D illustrates an elevation view of a caster assembly for conduit rack transport and installation cart 100.

FIG. 1E illustrates an elevation view of lower receiver elements of conduit rack transport and installation cart 100.

FIG. 1F illustrates a plan view of a cart spacer element for use with conduit rack transport and installation cart 100.

FIG. 1G illustrates an elevation view of conduit rack transport and installation carts 100 stacked with spacer elements.

FIG. 1H illustrates an elevation view of conduit rack transport and installation carts 100 stacked without spacer elements.

FIG. 2A illustrates a perspective view of a tall conduit rack transport and installation cart 200 configured for use as a bottom cart when required with a forklift.

FIG. 2B illustrates an elevation view of tall conduit rack transport and installation cart 200 configured for use as a bottom cart when required with a forklift.

FIG. 3A illustrates a perspective view of conduit rack transport and installation carts 300 stacked and mounted with preassembled conduit runs clamped to conduit trapeze hangers.

FIG. 3B illustrates a perspective view of conduit rack transport and installation carts 300 stacked and mounted with preassembled conduit runs clamped to conduit trapeze hangers.

### DETAILED DESCRIPTION

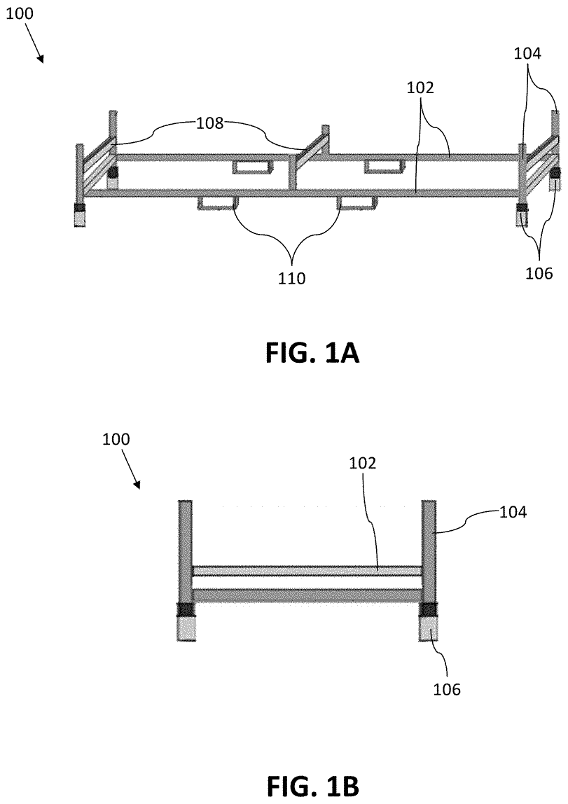

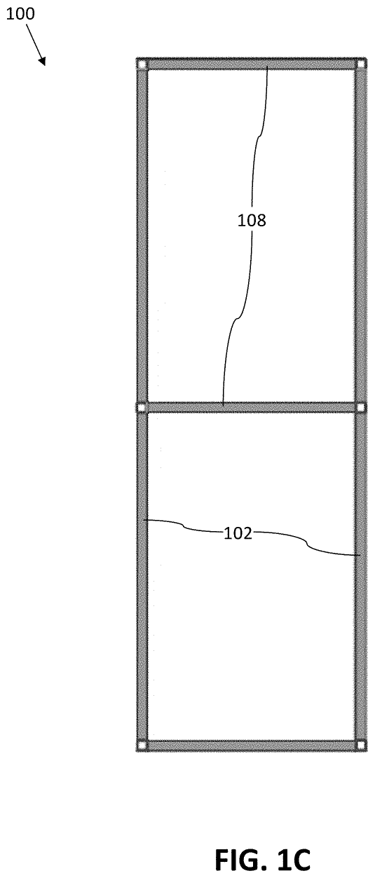

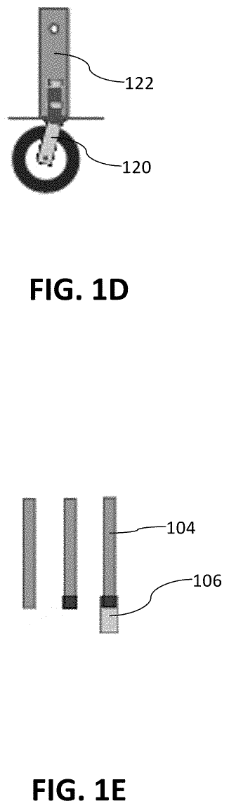

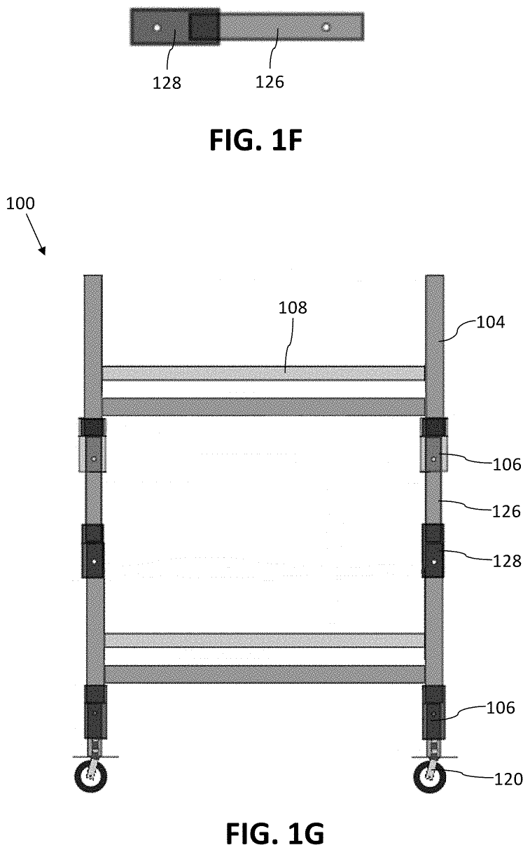

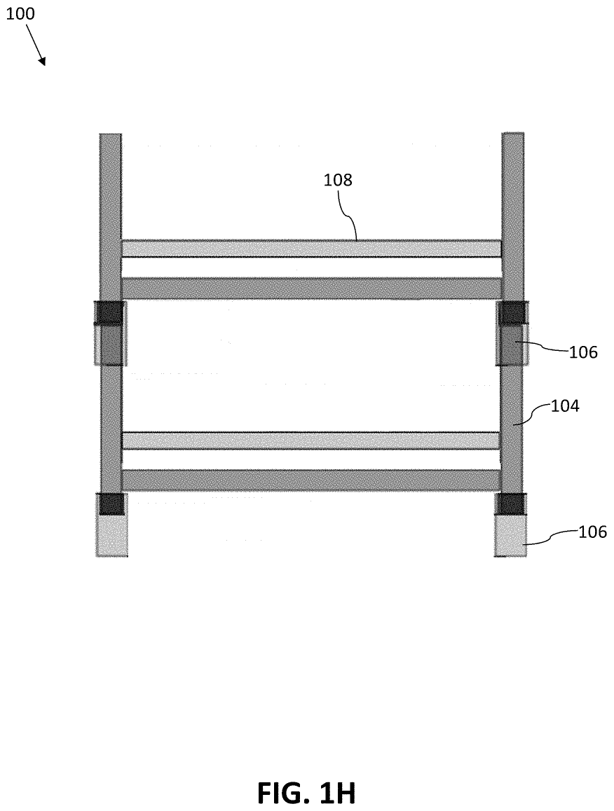

FIGS. 1A-1H illustrates a conduit rack transport and installation cart 100. Cart 100 includes base frame elements 102 generally forming a rectangle. Cart 100 includes vertical stacking elements 104 extending vertically from the four corners of the rectangle formed by frame elements 102, when frame elements 102 are oriented horizontally. The lower ends of vertical stacking elements 104 include a female receiver element 106 (see FIG. 1E) sized and configured to receive the top portion of vertical stacking elements 104 of another cart 100. Cart 100 may include raised conduit supports 108 extending across the width of cart 100 in a lateral direction. Conduit supports 108 may support assembled runs of conduit placed upon cart 100. Cart 100 may include fork pockets 110 on a lower side of base frame elements 102, configured to receive and at least partially engage the forces of a forklift.

FIG. 1D illustrates a caster assembly for conduit rack transport and installation cart 100, including a caster 120 and an upper male connection element 122. Male connection element 122 may be configured to fit within and engage female receiver element 106. Where desired, a pin can be placed through the receiver elements 106, 122 to at least temporarily pin the caster assembly to cart 100.

FIG. 1F illustrates a cart spacer element 126 having a female receiver element 128. FIG. 1G illustrates conduit rack transport and installation carts 100 stacked with spacer elements 126. Spacer elements 126 increase the vertical distance between carts 100 when stacked, to accommodate taller (that is, vertically larger) conduit assemblies. Female receiver element 128 receives the top portion of vertical stacking elements 104, and the top portion of spacer element 126 is received by female receiver element 106. As illustrated in FIG. 1G, casters 120 may be oriented on the bottom cart 100 in a stack of carts, thus permitting the entire stack of carts 100 to be wheeled around as necessary. Each cart 100 is the same and any cart 100 can be the bottom section with casters 120. Where desired, a pin can be placed through female receiver element 128 and vertical stacking element 104, and/or spacer element 126 and female receiver element 106 to at least temporarily pin the caster assembly to cart 100.

FIG. 1H illustrates conduit rack transport and installation carts 100 stacked without spacer elements 126.

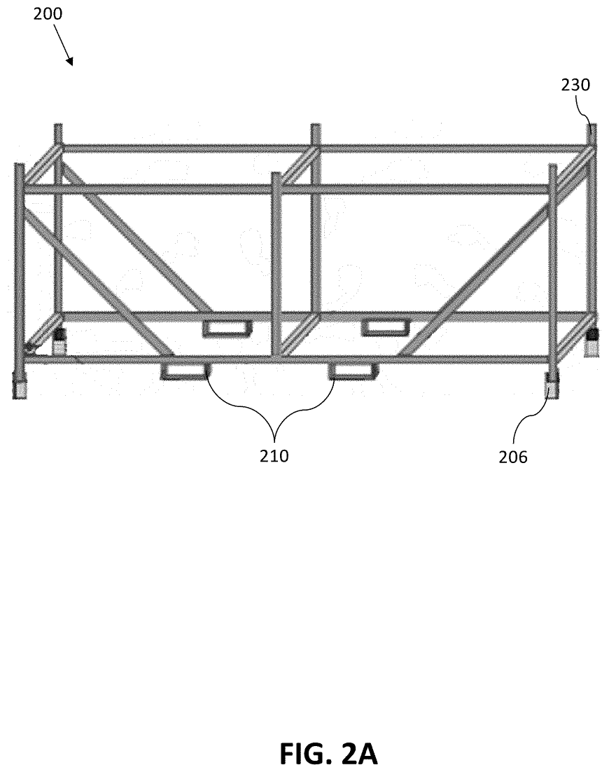

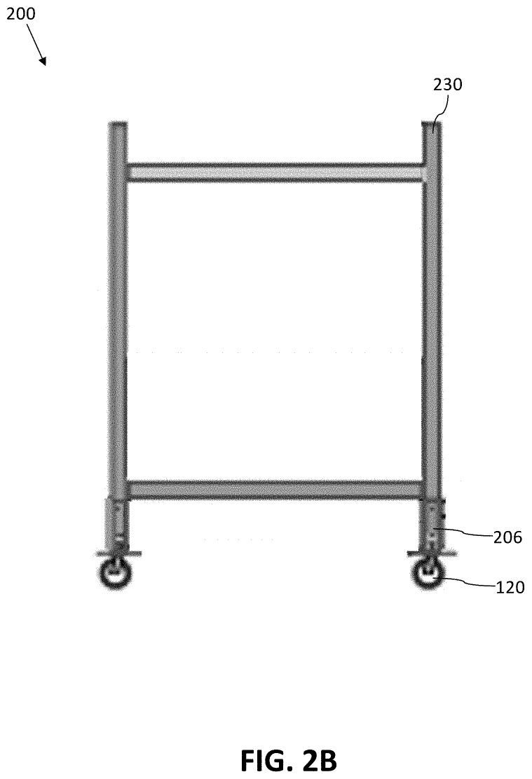

FIGS. 2A and 2B illustrate a tall conduit rack transport and installation cart 200 configured for use as a bottom cart when required with a forklift. It is contemplated that a forklift may be used to lift individual carts 100 preloaded with conduit runs (the conduit being clamped on trapeze hangers already) upward an into position, after which an installer may simply connect the trapeze hangers to the ceiling, cart 100 thereafter being lowered by the forklift and set aside.

It is common for forklifts to have a vertical safety cage oriented between the forks and the operator so as to prevent materials being lifted by the forks to fall backward off of the forks and strike the operator. Where conduit runs are required to be installed particularly close to a ceiling, the forklift may not be able to lift cart 100 close enough to the ceiling for installation due to the height of the forklift's vertical safety cage. In such a situation, cart 100 is placed upon a taller cart 200, and the forklift lifts both cart 200 and cart 100 upwardly until cart 100 is in position. The height (e.g., 48.0 in.) of cart 200 allows cart 100 to clear the forklift's safety cage and eliminates concerns regarding the safety cage striking the ceiling. Cart 200 allows any of carts 100 to be attached to its top and is used as a base section for the field forklift to use for installation. The forklift forks may engage the fork pockets 210 of cart 200.

Cart 200 has vertical stacking elements 230 with upper portions being the same as those of vertical stacking elements 104. Cart 200 includes female receiver elements 206 at a lower end of vertical stacking elements 104.

Casters 120 may be received in and connected to female receiver elements 206.

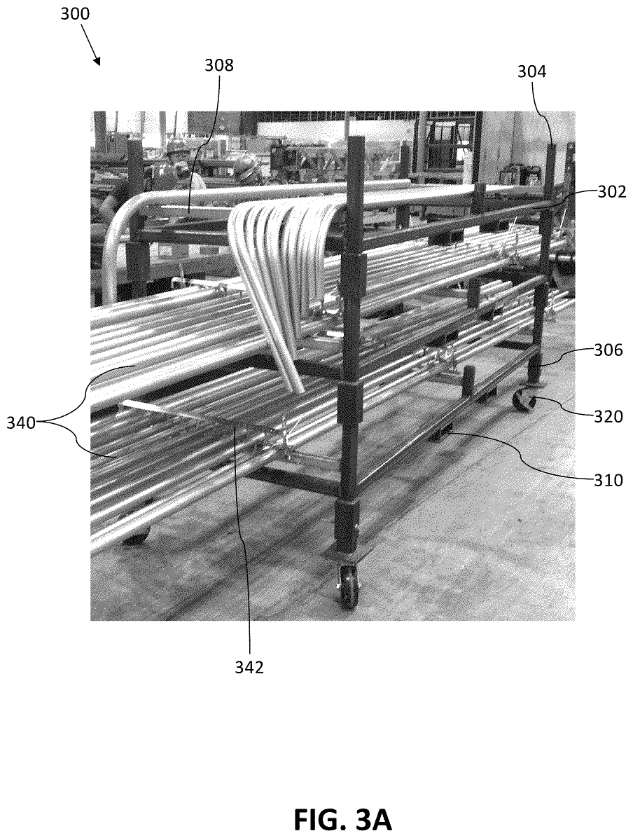

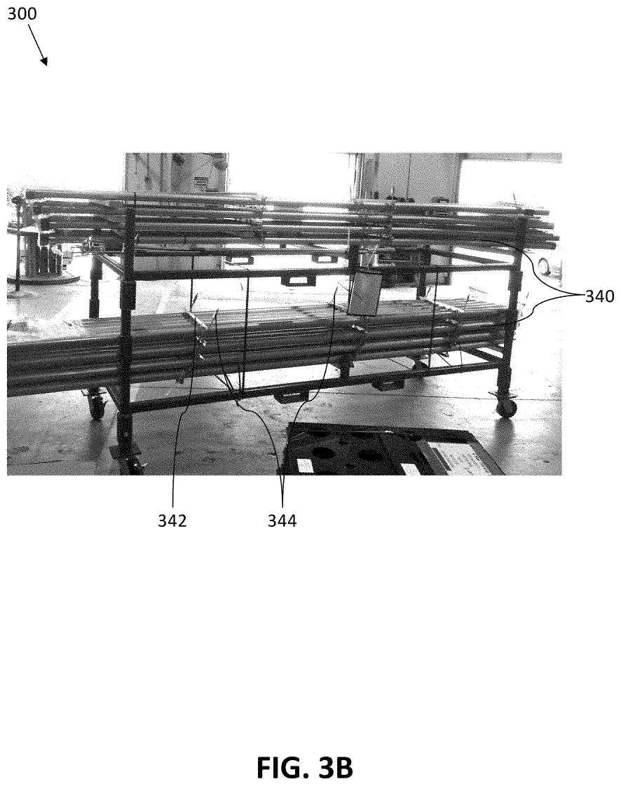

FIGS. 3A and 3B illustrate conduit rack transport and installation carts 300 stacked and mounted with preassembled conduit runs clamped to conduit trapeze hangers. For example, FIG. 3A illustrates three carts 300 stacked, whereas FIG. 3B illustrates two carts 300 stacked. Cart 300 includes vertical stacking elements 304 extending vertically from the four corners of the rectangle formed by frame elements 302, when frame elements 302 are oriented horizontally. The lower ends of vertical stacking elements 304 include a female receiver element 306 sized and configured to receive the top portion of vertical stacking elements 304 of another cart 300. Cart 300 may include raised conduit supports 308 extending across the width of cart 300 in a lateral direction. Cart 300 may include fork pockets 310 on a lower side of base frame elements 302, configured to receive and at least partially engage the forces of a forklift.

Carts 300 include casters 320 engaged with female receiver elements 306 of the lowest cart 300.

Carts 300 include conduit 340 preassembled with trapeze hangers 342 connected to conduit 340. In practice, the assembled conduit runs are lifted to the ceiling via a forklift's engagement with fork pockets 310, at which point trapeze hangers 342 are connected to the ceiling. Trapeze hangers may be fitted with short sections of threaded rod 344 or cable studs as illustrated in FIG. 3B. Rod 344 may be coupled to other sections of threaded rod extending downwardly from the ceiling of the structure to facilitate quick installation of conduit 340.

Typically, hangers and conduit runs are installed onsite, and individual conduits are installed on the hangers. This results in two separate tasks with two separate trips with lifts to the same location (up near the ceiling). This results in additional time and additional danger associated with increased use of a lift. The use of carts 300 with preassembled conduit runs eliminates these issues.

Preassembled loaded carts 300 are stacked on top of each other, with the top one being installed first and the bottom cart having caster wheels attached. Carts 300 may be shipped stacked. Installers at the site will remove the top cart and place it onto the high install cart 200 if forklift cage clearance is needed. The forklift will raise the carts 300 (and 200 if necessary) and conduit 340 into position. Once the conduit hangers 342 have been attached to the building structure the empty cart 300 will be lowered to the ground and exchanged for the next cart 300 holding the next section of conduit 340. When all carts 300 are empty, they are stacked back together to return to the prefabrication shop for reuse. The ability to prefabricate offsite and be able to ship and install with the same unit will reduce cost by reducing the number of trips a worker in a lift makes to the same area. The time savings due to delivery of conduit ready to install will reduce the amount of lay-down space required onsite to store material. The removable casters allow for interchangeability and mobility from the prefabrication shop to the job site.

Alternatively, a forklift may be used to raise an entire stack of preassembled loaded carts 300 but engaging the lowermost fork pockets 310, installing first the uppermost cart 300, then the next cart 300 below that, and so on until all carts 300 in a stack are installed.

In one embodiment, a conduit rack transport and installation cart is provided, comprising: base frame elements oriented into a horizontal rectangle having four corners; vertical stacking elements extending vertically upwardly from the four corners, wherein a lower end of each vertical stacking element includes a female receiver element sized to accept insertion of an upper end of each vertical stacking element; and a plurality of raised conduit supports extending across a width of the cart in a lateral direction.

The conduit rack transport and installation cart further comprising: fork pockets extending from a lower side of the base frame elements.

The conduit rack transport and installation cart further comprising: removable casters engaging the female receiver elements.

The conduit rack transport and installation cart further comprising a series of conduit rack transport and installation carts stacked one upon another.

The conduit rack transport and installation cart further comprising spacer elements oriented between adjacent carts.

The conduit rack transport and installation cart wherein the spacer element includes a spacer female receiver element and a top portion, wherein the top portion engages a vertical stacking element female receiver element, and wherein the spacer female receiver element engages the upper end of the vertical stacking element.

The conduit rack transport and installation cart further comprising a tall conduit rack transport and installation cart oriented lowermost in a series of conduit rack transport and installation carts stacked one upon another.

The conduit rack transport and installation cart wherein the tall conduit rack transport and installation cart have female receiver elements at a lower end of its vertical stacking elements, and further comprising removable casters engaging the female receiver elements.

The conduit rack transport and installation cart further comprising conduit supported by the raised conduit supports.

The conduit rack transport and installation cart further comprising trapeze hangers connected to the conduit, and securing each element of conduit to adjacent elements of conduit.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of alternative aspects thereof, and while the aspects have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A conduit rack transport and installation cart, comprising:
base frame elements oriented into a horizontal rectangle having four corners;
vertical stacking elements extending vertically upwardly from the four corners,
wherein a lower end of each vertical stacking element includes a female receiver element sized to accept insertion of an upper end of each vertical stacking element; and
a plurality of raised conduit supports extending across a width of the cart in a lateral direction.

2. The conduit rack transport and installation cart of claim 1, further comprising: fork pockets extending from a lower side of the base frame elements.

3. The conduit rack transport and installation cart of claim 1, further comprising: removable casters engaging the female receiver elements.

4. The conduit rack transport and installation cart of claim 1, further comprising a series of conduit rack transport and installation carts stacked one upon another.

5. The conduit rack transport and installation cart of claim 4, further comprising spacer elements oriented between adjacent carts.

6. The conduit rack transport and installation cart of claim 5, wherein the spacer element includes a spacer female receiver element and a top portion, wherein the top portion engages a vertical stacking element female receiver element, and wherein the spacer female receiver element engages the upper end of the vertical stacking element.

7. The conduit rack transport and installation cart of claim 1, further comprising a tall conduit rack transport and installation cart oriented lowermost in a series of conduit rack transport and installation carts stacked one upon another.

8. The conduit rack transport and installation cart of claim 7, the tall conduit rack transport and installation cart having female receiver elements at a lower end of its vertical stacking elements, and further comprising removable casters engaging the female receiver elements.

9. The conduit rack transport and installation cart of claim 1, further comprising conduit supported by the raised conduit supports.

10. The conduit rack transport and installation cart of claim 9, further comprising trapeze hangers connected to the conduit, and securing each element of conduit to adjacent elements of conduit.

11. A conduit rack transport and installation cart, comprising:
base frame elements oriented into a horizontal rectangle having four corners;
vertical stacking elements extending vertically upwardly from the four corners,
wherein a lower end of each vertical stacking element includes a female receiver element sized to accept insertion of an upper end of each vertical stacking element;
a plurality of raised conduit supports extending across a width of the cart in a lateral direction; and
fork pockets extending from a lower side of the base frame elements.

12. The conduit rack transport and installation cart of claim 11, further comprising: removable casters engaging the female receiver elements.

13. The conduit rack transport and installation cart of claim 11, further comprising a series of conduit rack transport and installation carts stacked one upon another.

14. The conduit rack transport and installation cart of claim 13, further comprising spacer elements oriented between adjacent carts.

15. The conduit rack transport and installation cart of claim 14, wherein the spacer element includes a spacer female receiver element and a top portion, wherein the top portion engages a vertical stacking element female receiver element, and wherein the spacer female receiver element engages the upper end of the vertical stacking element.

16. The conduit rack transport and installation cart of claim 11, further comprising a tall conduit rack transport and installation cart oriented lowermost in a series of conduit rack transport and installation carts stacked one upon another.

17. The conduit rack transport and installation cart of claim 16, the tall conduit rack transport and installation cart having female receiver elements at a lower end of its vertical stacking elements, and further comprising removable casters engaging the female receiver elements.

18. The conduit rack transport and installation cart of claim 11, further comprising conduit supported by the raised conduit supports.

19. The conduit rack transport and installation cart of claim 18, further comprising trapeze hangers connected to the conduit, and securing each element of conduit to adjacent elements of conduit.
